(19) United States
(12) Patent Application Publication
(10) Pub. No.: US 2025/0192988 A1
(43) Pub. Date: Jun. 12, 2025

(54) QUANTUM-RESISTANT EDGE ENCRYPTION

(71) Applicant: Dell Products L.P., Round Rock, TX (US)

(72) Inventors: Parminder Singh SETHI, Punjab (IN); Srinath KAPPGAL, Cork (IE); Daniel L. HAMLIN, Round Rock, TX (US); Malathi RAMAKRISHNAN, Madurai (IN); Praveen KUMAR, Noida (IN)

(73) Assignee: Dell Products L.P., Round Rock, TX (US)

(21) Appl. No.: 18/537,476

(22) Filed: Dec. 12, 2023

(51) Int. Cl. H04L 9/08

(52) U.S. Cl. CPC H04L 9/08; H04L 9/40

(57) ABSTRACT

An information handling system may include at least one processor and a memory. The information handling system may be configured to implement a quantum-resistant encryption system configured to provide encryption services to a plurality of edge devices and a plurality of edge storage systems; wherein the encryption services include: encryption key management; secure communication protocols; security auditing and testing; and monitoring and management.

### TECHNICAL FIELD

The present disclosure relates in general to information handling systems, and more particularly to adaptive encryption techniques.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) for various purposes. A VM may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

Encryption and decryption of data involves many challenges, and existing techniques have various shortcomings. For example, traditional encryption algorithms may become vulnerable to attacks by quantum computers, compromising the security of data in transit and data being stored. Further, edge computing environments have unique characteristics and constraints that must be addressed by a suitable encryption system.

Embodiments of this disclosure thus provide improvements in the encryption of data, particularly in the edge computing context.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with encryption in information handling systems may be reduced or eliminated.

In accordance with embodiments of the present disclosure, an information handling system may include at least one processor and a memory. The information handling system may be configured to implement a quantum-resistant encryption system configured to provide encryption services to a plurality of edge devices and a plurality of edge storage systems; wherein the encryption services include: encryption key management; secure communication protocols; security auditing and testing; and monitoring and management.

In accordance with these and other embodiments of the present disclosure, a method may include an information handling system implementing a quantum-resistant encryption system; and the information handling system providing, via the quantum-resistant encryption system encryption services to a plurality of edge devices and a plurality of edge storage systems; wherein the encryption services include: encryption key management; secure communication protocols; security auditing and testing; and monitoring and management.

In accordance with these and other embodiments of the present disclosure, an article of manufacture may include a non-transitory, computer-readable medium having computer-executable instructions thereon that are executable by a an information handling system processor of for: implementing a quantum-resistant encryption system; and providing, via the quantum-resistant encryption system encryption services to a plurality of edge devices and a plurality of edge storage systems; wherein the encryption services include: encryption key management; secure communication protocols; security auditing and testing; and monitoring and management.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates an example architecture, in accordance with embodiments of the present disclosure; and

FIG. 3 illustrates an example method, in accordance with embodiments of the present disclosure.

### DETAILED DESCRIPTION

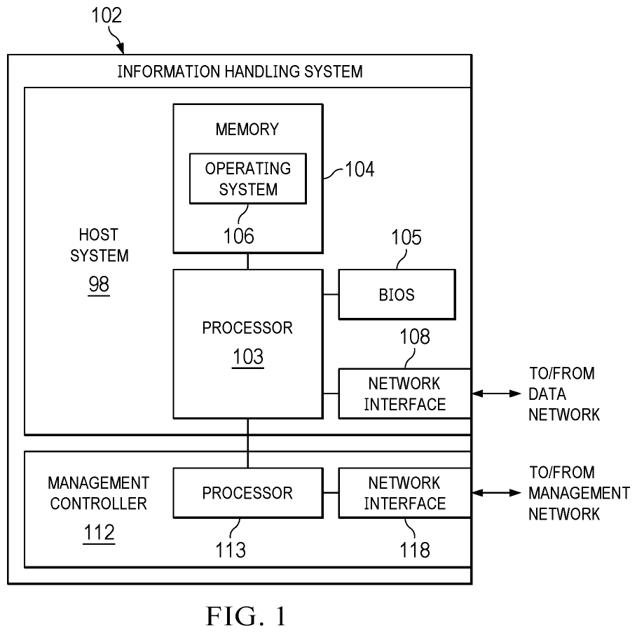

Preferred embodiments and their advantages are best understood by reference to FIGS. 1 through 3, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure provide improvements in data encryption and decryption in information handling systems 102 (e.g., edge nodes). It should be noted that while the scenario of an edge deployment is discussed in detail herein for the sake of concreteness, other embodiments are also specifically contemplated within the scope of this disclosure.

Embodiments of this disclosure provide an adaptive, post-quantum encryption infrastructure, which may be particularly useful in an edge computing environment.

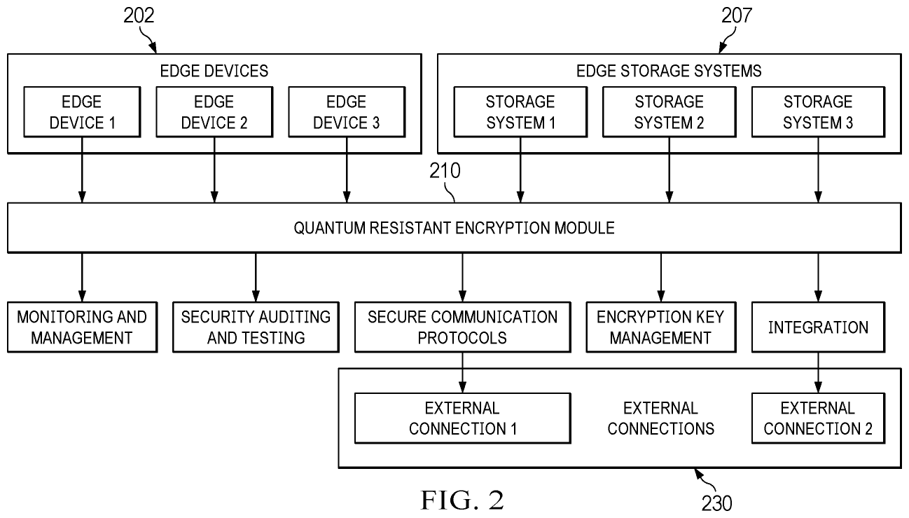

FIG. 2 illustrates an example architecture. Some embodiments may provide some or all of the following aspects:
1. Secure data transmission and storage at the edge: data is protected at the edge against potential threats from quantum computing.
2. Quantum-resistant encryption algorithms and protocols: encryption algorithms and protocols are used that are resilient against attacks from quantum computers.
3. Future-proof security: the security of infrastructure and data is ensured by safeguarding against advancements in computing (both quantum and non-quantum).
4. Edge computing environment: encryption mechanisms are used that are suitable for edge devices and storage systems.
5. Protection against breaches: the risk of unauthorized access and data breaches is mitigated by incorporating quantum-resistant encryption.
6. Confidentiality and integrity: confidentiality and integrity of data is preserved during transmission and storage at the edge.
7. Integration: the solution seamlessly integrates with other products, services, and infrastructure provided by the manufacturer of the information handling systems.
8. Efficiency and performance: encryption mechanisms are used that have minimal impact on the performance of edge devices and storage systems.
9. Testing and validation: thorough testing, security audits, and validation are used to ensure the effectiveness and resilience of the implemented encryption algorithms and protocols.

At the core of the architecture of FIG. 2, quantum-resistant encryption module 210 serves as the foundation for secure data transmission and storage at the edge. Module 210 may be implemented as software, hardware, firmware, or any combination thereof. In some embodiments, module 210 may be integrated into edge devices 202 and/or edge storage systems 207.

Edge devices 202 represent devices at the edge of the network, such as internet-of-things (IoT) devices, gateways, or edge servers, while edge storage systems 207 represent the storage systems where data is securely stored.

Quantum resistant encryption module 210 may implement advanced encryption algorithms and protocols, such as lattice-based, code-based, hash-based, isogeny-based, multivariate, and/or quantum-resistant symmetric key cryptography. It connects with edge devices 202 and edge storage systems 207, ensuring secure communication and encryption of data in transit or at rest.

Monitoring and management includes tools used to oversee the security of the encrypted data transmission and storage at the edge. This includes logging, event management, and reporting capabilities.

Security auditing and Testing is used to validate the effectiveness and resilience of the encryption algorithms and protocols. This comprehensive approach ensures that the system is robust and secure against potential threats.

To establish secure communication channels, module 210 integrates secure communication protocols, enabling authentication, data integrity, and confidentiality mechanisms. This ensures that data is transmitted securely between edge devices 202, edge storage systems 207, and any external connections.

Encryption key management is used in generating, storing, and distributing encryption keys. It ensures that the encryption and decryption processes use strong and unique keys, enhancing the overall security of the system.

Integration is a module configured to communicate with other systems (e.g., cloud-based systems) and tools provided by the manufacturer of edge devices 202.

External connections 230 are also shown, representing connections to cloud services, remote management systems, or other networks. These connections enable data exchange and management with external entities, enhancing the functionality and reach of the system.

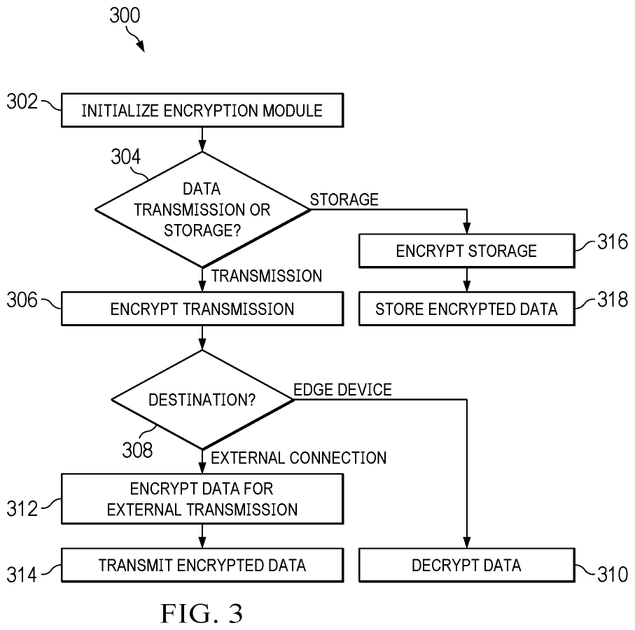

FIG. 3 illustrates a flowchart of an example method 300. At step 302, the encryption module is initialized, which includes setting up the necessary quantum-resistant encryption algorithms and protocols. At step 304, the method determines whether the data in question needs to b transmitted or stored securely.

If data transmission is needed, then at step 306, the data is encrypted using the quantum-resistant encryption algorithms to ensure its security during transmission. At step 308, the method determines whether the destination device is an edge device or an external connection.

If the destination device is an edge device, then at step 310 the encrypted data is decrypted at the edge device. If the destination device is an external connection, then at step 312 the data is re-encrypted for secure transmission to the external connection. The encrypted data is then transmitted securely to the external connection at step 314 and the method ends.

If data storage is needed, then at step 316 the data is encrypted using the quantum-resistant encryption algorithms for secure storage. At step 318, the encrypted data is stored securely in the edge storage systems.

One of ordinary skill in the art with the benefit of this disclosure will understand that the preferred initialization points for the method depicted in FIG. 3 and the order of the steps comprising the method may depend on the implementation chosen. In these and other embodiments, the method may be implemented as hardware, firmware, software, applications, functions, libraries, or other instructions. Further, although FIG. 3 discloses a particular number of steps to be taken with respect to the disclosed method, the method may be executed with greater or fewer steps than depicted. The method may be implemented using any of the various components disclosed herein (such as the components of FIG. 1), and/or any other system operable to implement the methods.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system is configured to implement a quantum-resistant encryption system configured to provide encryption services to a plurality of edge devices and a plurality of edge storage systems;
wherein the encryption services include:
encryption key management;
secure communication protocols;
security auditing and testing; and
monitoring and management.

2. The information handling system of claim 1, wherein the information handling system is an element of a hyper-converged infrastructure (HCI) system.

3. The information handling system of claim 2, wherein the information handling system is an element of an edge deployment of the HCI system.

4. The information handling system of claim 1, wherein the quantum-resistant encryption system is configured to implement at least one encryption algorithm selected from the group consisting of lattice-based algorithms, code-based algorithms, hash-based algorithms, isogeny-based algorithms, multivariate algorithms, and quantum-resistant symmetric key cryptography algorithms.

5. The information handling system of claim 1, wherein the encryption services further include integration with at least one cloud service of a manufacturer of the information handling system.

6. The information handling system of claim 1, wherein the encryption services include encrypting data for transmission to an external information handling system.

7. A method comprising:
an information handling system implementing a quantum-resistant encryption system; and
the information handling system providing, via the quantum-resistant encryption system encryption services to a plurality of edge devices and a plurality of edge storage systems;
wherein the encryption services include:
encryption key management;
secure communication protocols;
security auditing and testing; and
monitoring and management.

8. The method of claim 7, wherein the information handling system is an element of a hyper-converged infrastructure (HCI) system.

9. The method of claim 8, wherein the information handling system is an element of an edge deployment of the HCI system.

10. The method of claim 7, wherein the quantum-resistant encryption system is configured to implement at least one encryption algorithm selected from the group consisting of lattice-based algorithms, code-based algorithms, hash-based algorithms, isogeny-based algorithms, multivariate algorithms, and quantum-resistant symmetric key cryptography algorithms.

11. The method of claim 7, wherein the encryption services further include integration with at least one cloud service of a manufacturer of the information handling system.

12. The method of claim 7, wherein the encryption services include encrypting data for transmission to an external information handling system.

13. An article of manufacture comprising a non-transitory, computer-readable medium having computer-executable instructions thereon that are executable by a processor of an information handling system for:
implementing a quantum-resistant encryption system; and
providing, via the quantum-resistant encryption system encryption services to a plurality of edge devices and a plurality of edge storage systems;
wherein the encryption services include:
encryption key management;
secure communication protocols;
security auditing and testing; and
monitoring and management.

14. The article of claim 13, wherein the information handling system is an element of a hyper-converged infrastructure (HCI) system.

15. The article of claim 14, wherein the information handling system is an element of an edge deployment of the HCI system.

16. The article of claim 13, wherein the quantum-resistant encryption system is configured to implement at least one encryption algorithm selected from the group consisting of lattice-based algorithms, code-based algorithms, hash-based algorithms, isogeny-based algorithms, multivariate algorithms, and quantum-resistant symmetric key cryptography algorithms.

17. The article of claim 13, wherein the encryption services further include integration with at least one cloud service of a manufacturer of the information handling system.

18. The article of claim 13, wherein the encryption services include encrypting data for transmission to an external information handling system.
